(19) United States
(12) Patent Application Publication
(10) Pub. No.: US 2014/0067204 A1
(43) Pub. Date: Mar. 6, 2014

(54) ELECTRONIC APPARATUS, PROCESSING SYSTEM, AND COMPUTER READABLE STORAGE MEDIUM

(71) Applicants: Kazuhiro Takahashi, Kawasaki-shi (JP); Mami Muratani, Tokyo (JP); Naoto Yamada, Yokohama-shi (JP); Shinjiro Muraki, Tokyo (JP); Yuya Adachi, Tokyo (JP); Masakazu Sekiguchi, Kawasaki-shi (JP)

(72) Inventors: Kazuhiro Takahashi, Kawasaki-shi (JP); Mami Muratani, Tokyo (JP); Naoto Yamada, Yokohama-shi (JP); Shinjiro Muraki, Tokyo (JP); Yuya Adachi, Tokyo (JP); Masakazu Sekiguchi, Kawasaki-shi (JP)

(73) Assignee: NIKON CORPORATION, Tokyo (JP)

(21) Appl. No.: 13/983,923

(22) PCT Filed: Feb. 9, 2012
(86) PCT No.: PCT/JP2012/052994

§ 371 Date: Nov. 6, 2013

(30) Foreign Application Priority Data
Mar. 4, 2011 (JP) 2011-047748
Mar. 4, 2011 (JP) 2011-047749

(51) Int. Cl. B60Q 5/00; B61D 27/00; B61K 13/04; B60H 1/00

(52) U.S. Cl. CPC B60Q 5/005; B60H 1/00742; B61D 27/0018; B61K 13/04
USPC 701/36

(57) ABSTRACT

Provided is an electronic apparatus that perform an appropriate process according to a gesture of a subject person, the electronic apparatus including: a first input unit that inputs a detection result of a biosensor detecting a change in biological information of a person; a second input unit that inputs a recognition result of a recognition device recognizing an action of the person; and a processor that performs a process according to the action of the person based on input results of the first and second input units.

### TECHNICAL FIELD

The present invention relates to an electronic apparatus, a processing system, and a processing program.

### BACKGROUND ART

There has been suggested an interface apparatus that allows a user to operate a device by performing a gesture for a camera (e.g. Patent Document 1).

### PRIOR ART DOCUMENTS

Patent Documents

Patent Document 1: Japanese Patent Application Publication No. 2004-246856

### SUMMARY OF THE INVENTION

Problems to be Solved by the Invention

However, the conventional interface device can not always determine whether an action taken by a user is a gesture accurately.

The present invention has been made in view of the above problem, and aims to provide an electronic apparatus, a processing system, and a processing program capable of performing an appropriate process according to an action of a subject person.

Means for Solving the Problems

An electronic apparatus of the present invention includes: a first input unit that inputs a detection result of a biosensor detecting a change in biological information of a subject person; a second input unit that inputs a recognition result of a recognition device recognizing an action of the subject person; and a processing unit that performs a process according to the action of the subject person based on input results of the first and second input units.

In this case, the recognition device may include different sensors, and the processing unit can perform the process according to the action of the subject person based on recognition results of the sensors that are input to the second input unit even when the change in biological information is not input to the first input unit.

In addition, the sensors may include an image capture device and a contact-type sensor, and the electronic apparatus may further includes a control unit that captures an image by the image capture device when the contact-type sensor recognizes an action of a subject person. In this case, the image capture device may be located higher than the contact-type sensor.

In addition, in the electronic apparatus of the present invention, at least a part of the recognition device may be located near the biosensor. In addition, the processing unit may perform a process to emit a sound by a loudspeaker emitting a sound to the subject person, and the loudspeaker may be a directional loudspeaker emitting the sound to a limited direction.

In addition, in the electronic apparatus in the present invention, the processing unit may receive a sound emitted from the subject person from a sound input device that inputs a sound. In this case, a sound recognition unit that recognizes a sound received from the sound input device may be included.

In addition, the electronic apparatus of the present invention may further includes a timer that measures a time during which biological information of the subject person is changing and a time during which the action of the subject person is being recognized, and the processing unit may performs a process according to the input results and a time measurement result of the timer. In addition, the processing unit may perform, when the subject person is present in a moving equipment that is movable, the process taking a detection result of a detection device that detects a movement of the moving equipment into consideration. In addition, the first input unit may input the change in biological information by human body communication.

A processing system of the present invention is a processing system including: a biosensor that detects a change in biological information of a subject person; a recognition device that recognizes an action of the subject person; and the electronic apparatus of the present invention. In this case, the biosensor may detect the change in biological information from at least one of a hand and buttocks of the subject person.

An electronic apparatus of the present invention is an electronic apparatus including: a first input unit that inputs a detection result of a first sensor that detects a movement of a first part of a body; a second input unit that inputs a detection result of a second sensor that differs from the first sensor and detects a movement of a second part of the body different from the first part; and a determination unit that determines whether the first part and the second part belong to a same person.

In this case, a processing unit that performs a process according to detection results input from the first and second input units when the determination unit determines that the first part and the second part belong to the same person may be included.

In addition, the determination unit may determine whether the first part and the second part belong to the same person based on positional information of the first sensor that has detected the movement of the first part and positional information of the second sensor that has detected the movement of the second part.

In addition, the first sensor may be a contact-type sensor that contacts the first part to detect the movement of the first part, and the second sensor may be a contact-type sensor that contacts the second part to detect the movement of the second part.

In addition, one of the first sensor and the second sensor may be a hand detection sensor that detects a movement of a hand, and the other of the first sensor and the second sensor may be a foot detection sensor that detects a movement of a foot.

In addition, the first sensor may be a contact-type sensor that contacts the first part to detect the movement of the first part, and the second sensor may be a non-contact sensor that detects the movement of the second part without contacting the second part.

In addition, the second sensor may be a head detection sensor that detects a movement of a head.

The electronic apparatus of the present invention may further include a third input unit that inputs a detection result of a third sensor that detects a movement of a third part of the body different from the first and second parts.

In addition, a fourth input unit that inputs a detection result of a biosensor that detects a change in biological information of the body may be included.

An electronic apparatus of the present invention is an electronic apparatus including: a first input unit that inputs a detection result of a non-contact sensor that detects a movement of a head without physical contact; a second input unit that inputs a detection result of a contact sensor that contacts a part of a body other than the head to detect a movement of the part; and a processing unit that performs a process according to detection results input from the first and second input units.

In this case, a control unit that performs detection by the non-contact sensor when the contact sensor detects the movement may be included. In addition, a determination unit that determines whether the head of which a movement has been detected by the non-contact sensor and the part of the body of which a movement has been detected by the contact sensor belong to a same person may be included.

In addition, the processing unit may perform a process according to detection results input from the first and second input units when a determination result by the determination unit shows that the head of which the movement has been detected by the non-contact sensor and the part of the body of which the movement has been detected by the contact sensor belong to the same person.

In addition, the contact sensor may include a first sensor that detects a movement of a first part of the body and a second sensor that detects a movement of a second part different from the first part.

In addition, a biological information input unit that inputs a detection result of a biosensor that detects a change in biological information of a body may be included.

A processing system of the present invention is a processing system including: a first sensor that detects a movement of a first part of a body; a second sensor that detects a movement of a second part of the body different from the first part; and the electronic apparatus of the present invention.

A processing system of the present invention is a processing system including: a non-contact sensor that detects a movement of a head without physical contact; a contact sensor that contacts a part of a body other than the head to detect a movement of the part; and the electronic apparatus of the present invention.

A processing program of the present invention is a processing program causing a computer to perform a process, the process including: a first input step that inputs a detection result of a biosensor detecting a change in biological information of a subject person; a second input step that inputs a recognition result of a recognition device recognizing an action of the subject person; and a processing step that performs a process according to the action of the subject person based on input results at the first and second steps.

A processing program of the present invention is a processing program causing a computer to perform a process, the process including: a first input step that inputs a detection result of a first sensor that detects a movement of a first part of a body; a second input step that inputs a detection result of a second sensor that differs from the first sensor and detects a second part of the body different from the first part; and a determination step that determines whether the first part and the second part belong to a same person.

A processing program of the present invention is a processing program causing a computer to perform a process, the process including: a first input step that inputs a detection result of a non-contact sensor that detects a movement of a head without physical contact; a second input step that inputs a detection result of a contact sensor that contacts a part of a body other than the head to detect a movement of the part; and a processing step that performs a process according to detection results input from the first and second input units.

Effects of the Invention

An electronic apparatus, a processing system, and a processing program of the present invention can perform an appropriate process in accordance with an action of a subject person.

### BRIEF DESCRIPTION OF DRAWINGS

FIG. 1 is a diagram schematically illustrating a configuration of a trouble handling system in accordance with an exemplary embodiment;

FIG. 2 is a diagram illustrating an example of installation of the trouble handling system into a train;

FIG. 3 is a diagram illustrating a pressure sensor and a biosensor provided on a strap;

FIG. 4 is a diagram illustrating an exemplary reference image;

FIG. 5 is a diagram illustrating a hardware configuration of an electronic apparatus;

FIG. 6 is a functional block diagram of the electronic apparatus; and

FIG. 7 is a flowchart illustrating a process executed by the trouble handling system (processing and control unit of the electronic apparatus).

### MODES FOR CARRYING OUT THE INVENTION

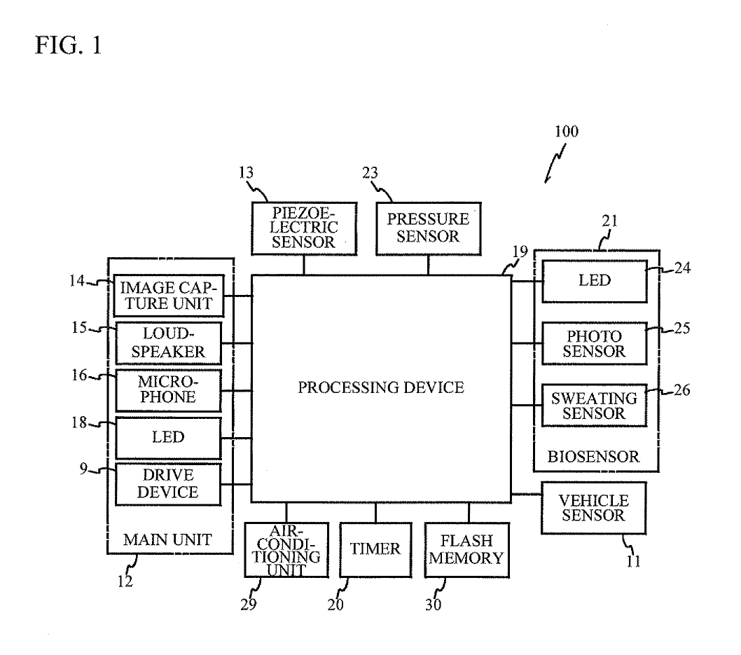

Hereinafter, a detailed description will be given of a trouble handling system 100 in accordance with an exemplary embodiment. FIG. 1 is a block diagram illustrating a sketchy configuration of the trouble handling system 100. As illustrated in FIG. 1, the trouble handling system 100 includes a processing device 19, a main unit 12, a biosensor 21, a piezoelectric sensor 13, a pressure sensor 23, a vehicle sensor 11, an air-conditioning unit 29, a timer 20, and a flash memory 30.

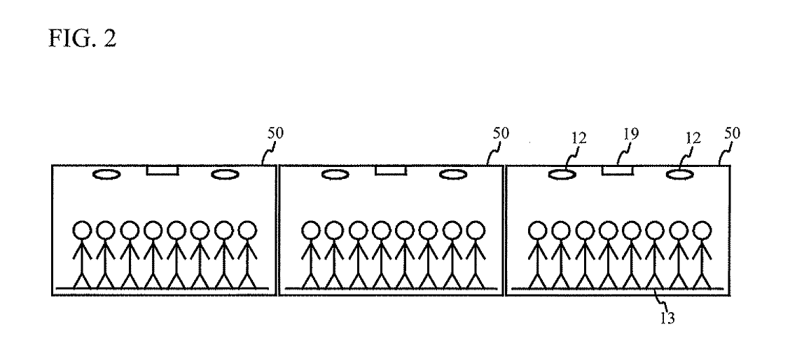

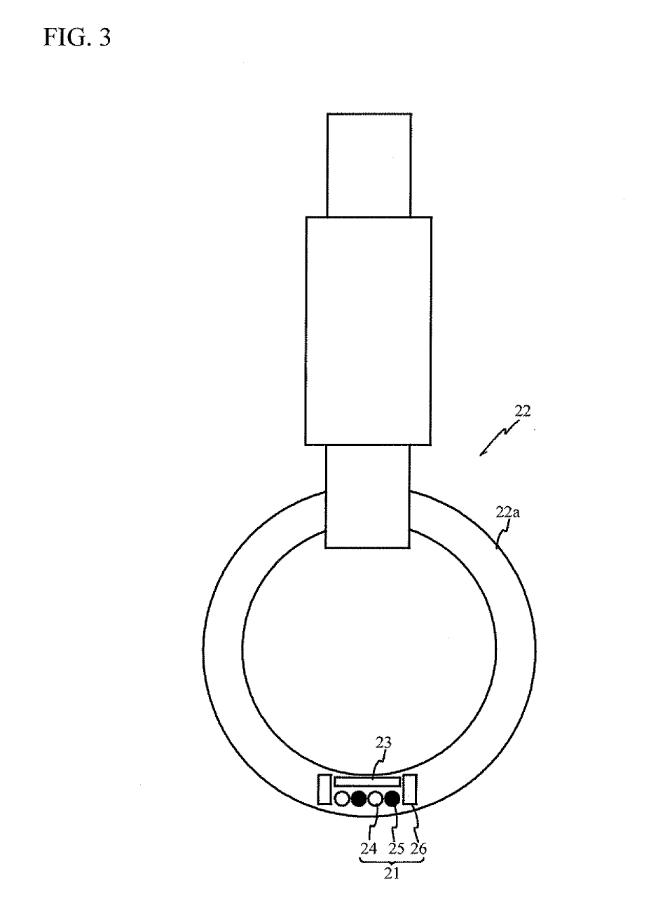

FIG. 2 illustrates an example of installation of the trouble handling system 100. As illustrated in FIG. 2, the present embodiment installs the trouble handling system 100 in a train 50. For example, the processing device 19 and the main unit 12 are located on a ceiling portion of the train 50, and the piezoelectric sensor 13 is located on a floor surface of the train 50. In addition, the biosensor 21 and the pressure sensor 23 are located on a strap 22 in the train 50 (see FIG. 3). Further, other devices are located in the train 50.

As illustrated in FIG. 1, the main unit 12 includes an image capture unit 14, a loudspeaker 15, a microphone 16, an LED (Light Emitting Diode) 18, and a drive device 9. The main unit 12 may include the above devices as one unit, or at least one of the above devices may be located separately from others.

The image capture unit 14 includes an imaging lens, an imaging element such as a CCD (Charge Coupled Device) or CMOS (Complementary Metal Oxide Semiconductor), and a control circuit that controls the imaging element. The image capture unit 14 is located on the ceiling portion of the train 50 as described previously, and thus mainly captures images of heads of passengers. Moreover, the image capture unit 14 captures the image of a passenger when the passenger looks toward the ceiling. The image capture unit 14 mainly captures heads to protect the privacy of passengers.

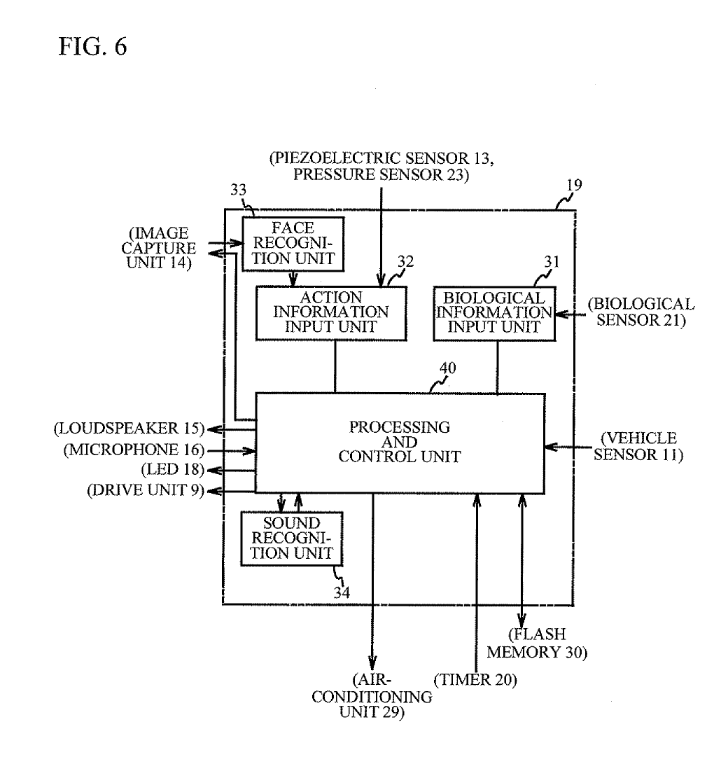

The loudspeaker 15 is used to make an announcement to suppress trouble when trouble occurs on the train, and to ask a passenger questions to check whether trouble occurs. The loudspeaker 15 outputs sounds synthesized by an artificial-voice technology such as “Are you all right?”, “Calm down, please.” or the like for example under the instruction of the processing device 19 (processing and control unit 40 (see FIG. 6)). Various loudspeakers may be used for the loudspeaker 15, and a directional loudspeaker or superdirective loudspeaker that includes an ultrasonic transducer and propagates sounds to only a limited direction may be used. When a loudspeaker with directionality is used, a sound can be emitted not across the train but toward the area in which trouble occurs.

The microphone 16 collects sounds in the train. The microphone 16 collects a sound emitted from a passenger in a case of trouble such as “Help.” or “Aiiieee.” and inputs it to the processing device 19 (processing and control unit 40).

The LED 18 emits a light beam to the area in which trouble occurs, and notifies passengers and a station employee of occurrence of the trouble.

The drive device 9 includes a sound coil motor for example, and adjusts locations and positions of the image capture unit 14, the loudspeaker 15, the microphone 16, and the LED 18.

Each car may be equipped with one or more main units 12 configured as described above (FIG. 2 illustrates a case of two). The number of the main units 12 to be provided can be determined in accordance with the image capture region of the image capture unit 14 (so that the image of the whole of the car can be captured).

The piezoelectric sensor 13 includes a piezo element, and converts force applied from the outside into voltage with the piezoelectric effect to electrically detect vibration. A number of the piezoelectric sensors 13 located so as to cover the whole area in the car enable to detect which position in the car vibrates.

For example, assume that a woman in a car gets bothered because she is being surrounded by two or more men, and steps on a floor (piezoelectric sensor 13) strongly several times. In this case, the piezoelectric sensor 13 detects the vibration and transmits the detection result to the processing device 19 (processing and control unit 40), and this allows the processing device 19 (processing and control unit 40) to detect the possibility of occurrence of trouble and the position of it. A method of detecting trouble will be described in detail later.

The timer 20 has a time measuring function, and measures a time during which the piezoelectric sensor 13 detects vibration. For example, when the vibration is continuously detected over five seconds or vibration is intermittently detected within a predetermined time period (e.g. 30 seconds), the timer 20 notifies the processing device 19 (processing and control unit 40) of that fact.

The biosensor 21 detects biological information such as heart rate, oxygen density in the blood, and blood pressure, and includes an LED 24, a photo sensor 25, and a sweating sensor 26 as illustrated in FIG. 1. The LED 24, the photo sensor 25, and the sweating sensor 26 are provided on a handrest part 22a of the strap 22 located in the train 50. More specifically, two or more LEDs 24 and photo sensors 25 are alternately provided on the handrest part 22a, and a pair of sweating sensors 26 are located so as to sandwich the LEDs 24 and the photo sensors 25.

The LED 24 and the photo sensor 25 are used to detect heart rate and oxygen density in the blood by irradiating a hand with a light beam emitted from the LED 24 and then receiving a reflected light beam by the photo sensor 25. The sweating sensor 26 measures impedance of a hand with two or more electrodes to detect an amount of sweating. The number and arrangement of the LED 24, the photo sensor 25, and the sweating sensor 26 may be arbitrarily determined.

In addition, the pressure sensor 23 is also provided on the handrest part 22a of the strap 22 in FIG. 3. A strain sensor may be used for the pressure sensor 23, or a sensor that detects a pressure from a change in capacitance may be used. The pressure sensor 23 detects that a passenger holds the strap 22, or detects that a passenger holds the strap 22 in an unusual manner (gesture) such as holding it tight when the passenger gets in trouble. The number and location of the pressure sensor 23 may be arbitrarily determined.

The present embodiment arranges a part of the biosensors 21 and the pressure sensor 23 close to each other as illustrated in FIG. 3, but may arrange them separately or pack them to one unit. The location of the strap 22 is preliminarily known, and the information about the location of each strap 22 is stored in the flash memory 30 or the like.

The vehicle sensor 11 includes a vibration sensor that detects the vibration of the train itself caused by moving and stopping of the train. In addition, the vehicle sensor 11 may include a temperature sensor that detects temperature in the car. The detection result of the vehicle sensor 11 is transmitted to the processing device 19 (processing and control unit 40).

The air-conditioning unit 29 air-conditions the car, and is controlled by the processing device 19 (processing and control unit 40) based on the number of heads (i.e. the number of passengers) of which images are captured by the image capture unit 14 in the present exemplary embodiment.

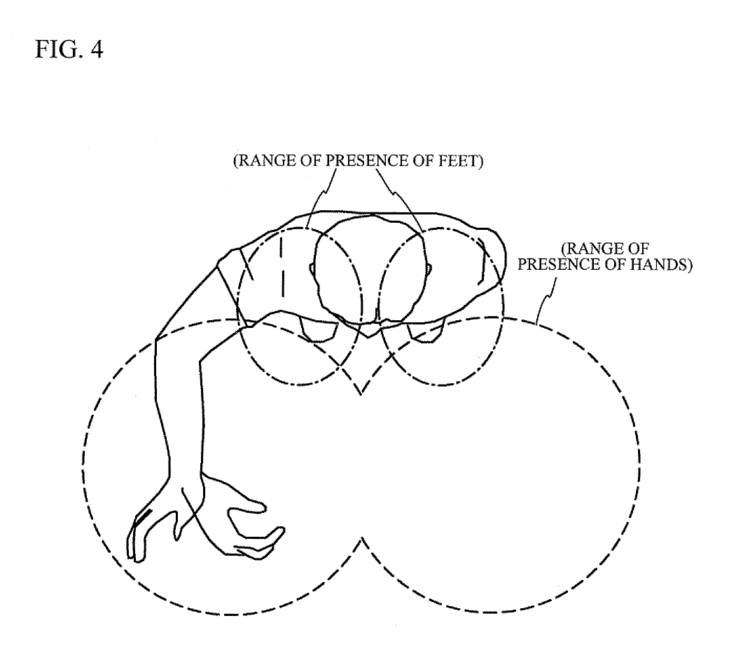

The flash memory 30 is a non-volatile memory that stores various kinds of data, and the present embodiment stores a reference image representing positions of hands and feet in accordance with the head of a passenger in the flash memory 30. FIG. 4 is a diagram illustrating an exemplary reference image. In FIG. 4, the region defined by a dashed line is a range in which hands are to be placed (range in which hands are likely to be placed) in accordance with the position of a head, and the region defined by a chain line is a range in which feet are to be placed in accordance with the position of the head.

A detailed description will next be given of the processing device 19. The processing device 19 controls the whole of the trouble handling system 100, and determines whether trouble occurs in the car based on the output from the biosensor 21, the piezoelectric sensor 13, and the pressure sensor 23. Moreover, the processing device 19 makes the main unit 12 and the like perform an operation and process to calm down trouble when trouble occurs.

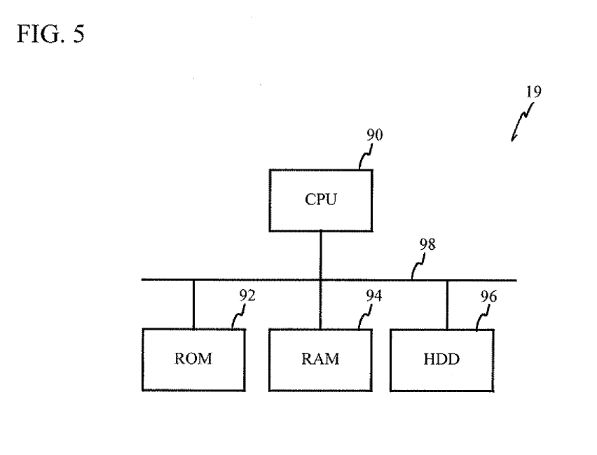

FIG. 5 illustrates a hardware configuration of the processing device 19. As illustrated in FIG. 5, the processing device 19 includes a CPU 90, a ROM 92, a RAM 94, a storing unit (here, HDD (Hard Disk Drive)) 96, and the like, and each component of the processing device 19 is coupled to a bus 98. The processing device 19 achieves the function of each unit in FIG. 6 by executing a processing program stored in the ROM 92 or the HDD 96 by the CPU 90.

FIG. 6 illustrates a functional block diagram of the processing device 19. As illustrated in FIG. 6, the processing device 19 functions as a biological information input unit 31, an action information input unit 32, a face recognition unit 33, a sound recognition unit 34, and a processing and control unit 40 by executing the processing program by the CPU 90.

The biological information input unit 31 receives the detection result detected in the biosensor 21. The biological information input unit 31 outputs the input information to the processing and control unit 40.

The action information input unit 32 receives the detection results detected in the piezoelectric sensor 13 and the pressure sensor 23 and the recognition result of the face recognition unit 33 described later. The action information input unit 32 outputs the input information to the processing and control unit 40.

The face recognition unit 33 acquires an image captured by the image capture unit 14 and detects a face image in the image. The face recognition unit 33 determines a face by detecting characterizing portions of the face such as eyes, nose, and mouth as images. The present embodiment provides the image capture unit 14 on the ceiling portion of a car, and thus it might be said that the face recognition unit 33 determines whether an approximate circular image included in the image captured by the image capture unit 14 is a head or face. In addition, the face recognition unit 33 detects the movement of a head without physical contact. There may be a situation that moving a face to look at the ceiling is difficult. Therefore, the face recognition unit 33 may employ an algorithm that determines that a face is detected when a passenger hangs his/her jaw open and the images of the forehead and eyes are captured by the image capture unit 14.

The sound recognition unit 34 has a sound recognition dictionary, and recognizes sounds input from the microphone 16 with the sound recognition dictionary. The present embodiment registers sounds emitted in a case of emergency such as “Help.” and “Aiiieee.” in the sound recognition dictionary. The microphone 16 inputs not only sounds but also loudness of the collected sounds (dB) to the processing and control unit 40. FIG. 6 illustrates that sounds input from the microphone 16 to the processing device 19 are input to the sound recognition unit 34 through the processing and control unit 40, but does not intend to suggest any limitation. The sound may be directly input from the microphone 16 to the sound recognition unit 34.

The processing and control unit 40 performs various processes and controls devices inside or outside the processing device 19 with information input from the inside or outside of the processing device 19. For example, the processing and control unit 40 determines whether the output from the biosensor 21, the piezoelectric sensor 13, and the pressure sensor 23 is the output from the same person (one passenger) based on the image of the head or face recognized by the face recognition unit 33 by using the reference image stored in the flash memory 30. In this case, the determination whether to be the same person is performed by pattern matching the enlarged or reduced and rotated reference image with a passenger. The processing and control unit 40 can enlarge or reduce the reference image based on the size of the head. The reason why the process is taken in this way is because the size of the body varies in accordance with the size of the head. The processing and control unit 40 can acquire the locations of the pressure sensor 23 that has detected a gesture and the biosensor 21 that has detected a change in biological information based on the positional information of the strap 22 (stored in the flash memory 30 or the like). Reference images for men, women, and children may be stored in the flash memory 30 with average physical sizes of them.

The processing and control unit 40 determines whether a passenger gets in trouble in the car based on the detection results of the biosensor 21, the piezoelectric sensor 13, and the pressure sensor 23. Here, the passenger who gets involved in trouble changes his/her biological information, or performs a gesture (action) such as stepping the floor several times, a gesture (action) such as holding the strap 22 tight, or a gesture (action) such as raising his/her head and looking at the ceiling. In addition, the passenger who gets involved in trouble may tremble his/her feet with fear, or unconsciously hold the strap 22 tight, and thus the passenger can unconsciously perform a gesture (action). Accordingly, the processing and control unit 40 determines whether trouble occurs based on information from the biosensor 21 and the piezoelectric sensor 13, the pressure sensor 23, and the face recognition unit 33. It might be said that the piezoelectric sensor 13, the pressure sensor 23, and the face recognition unit 33 are gesture (action) detection units because they detect the above described gestures (actions). Hereinafter, the piezoelectric sensor 13, the pressure sensor 23, and the face recognition unit 33 are collectively described as gesture detection units (13, 23, 33).

In addition, the processing and control unit 40 controls the drive device 9 driving the main unit 12 described previously to emit sounds or a light beam toward the location in which trouble occurs or collects sounds emitted in the location in which trouble occurs. Further, the processing and control unit 40 can perform the control to turn on the switch of the microphone 16 (usually, the off state is maintained) at a timing when it determines that trouble occurs based on the information from the biosensor 21 and piezoelectric sensor 13, the pressure sensor 23, and the face recognition unit 33. This can save energy. To save energy, the processing and control unit 40 may flash the LED 24 only while the pressure sensor 23 near the LED 24 and the photo sensor 25 located on the strap 22 are detecting that a passenger holds the strap.

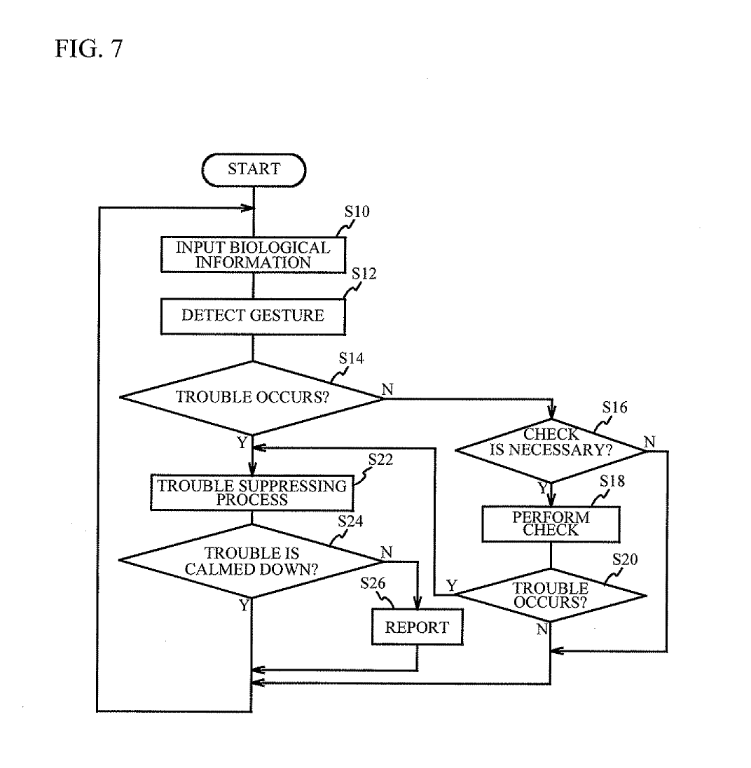

A description will next be given of a process and operation of the trouble handling system 100 configured as described above along a flowchart in FIG. 7.

In the process in FIG. 7, at step S10, the biological information input unit 31 inputs biological information supplied from the biosensor 21 to the processing and control unit 40. More specifically, the biological information input unit 31 inputs heart rate and oxygen density in the blood detected by the LED 24 and the photo sensor 25 to the processing and control unit 40, and also inputs the amount of sweating detected by the sweating sensor 26. The biological information input from the biosensor 21 to the biological information input unit 31 may be a piece of information or pieces of information. In addition, the biological information may include information about blood pressure for example. At step S10, the biological information input unit 31 repeatedly inputs biological information of passengers to the processing and control unit 40.

Then, at step S12, the processing and control unit 40 detects a gesture using the detection information of the piezoelectric sensor 13 and the pressure sensor 23 and the recognition result of the face recognition unit 33. The present embodiment detects a gesture using the piezoelectric sensor 13, the pressure sensor 23, and the face recognition unit 33, but may detect a gesture using at least one of the piezoelectric sensor 13, the pressure sensor 23, and a face recognition unit 17 in accordance with a situation of trouble detected. A gesture may be detected with a sensor other than the piezoelectric sensor 13, the pressure sensor 23, and the face recognition unit 17. The processing and control unit 40 may capture an image by the image capture unit 14 at least when the biosensor 21 detects biological information or when the piezoelectric sensor 13 or the pressure sensor 23 detects a gesture, and may turn off the switch of the image capture unit 14 (or stop power supply) otherwise.

The execution sequence of step 510 and step S12 may be switched. In this case, the detection by the biosensor 21 may be eliminated at step S12 in the strap in which the output from the pressure sensor 23 is not detected at step S10. In this case, the power may be supplied to the biosensor 21 at a timing when the pressure sensor 23 provided on the strap 22 detects the pressure.

Then, at step S14, the processing and control unit 40 determines whether trouble occurs on the train 50 based on the results at steps S10 and S12. More specifically, the processing and control unit 40 determines which passenger changes his/her biological information, which passenger has performed a gesture, and whether these passengers are the same passenger from the position of the head or face of the passenger and the positional relation between the biosensor 21 and the gesture detection units (the piezoelectric sensor 13, the pressure sensor 23) (positional relation between the hand and the foot) using the reference image (FIG. 4) stored in the flash memory 30. The processing and control unit 40 identifies the passenger, and then determines whether trouble occurs. In this case, the processing and control unit 40 determines that trouble occurs when one of the following judgmental standards (a) through (c) is satisfied.

(a) As to the same passenger, the biosensor 21 detects a change in heart rate or oxygen density in the blood, and at least one of the gesture detection units (13, 23, 33) detects a gesture performed by the passenger.

(b) As to the same passenger, the sweating sensor 26 detects an amount of sweating more than or equal to a given amount and at least one sensor of the gesture detection units (13, 23, 33) detects a gesture performed by the passenger although the temperature in the car detected by the vehicle sensor 11 (temperature sensor) is not high (e.g. less than or equal to 23° C.).

(c) As to the same passenger, the output from the pressure sensor 23 is not obtained (i.e. the output from the biosensor 21 is not obtained either), but the piezoelectric sensor 13 and the face recognition unit 33 detects a gesture with an amount greater than or equal to a given amount.

When an infrared sensor capable of detecting the body temperature of a passenger is located in a car, the processing and control unit 40 may determine that trouble occurs when the following judgmental standard (d) is satisfied.

(d) As to the same passenger, the output from the pressure sensor 23 is not obtained, but the infrared sensor detects the raise of the body temperature and at least one of the piezoelectric sensor 13 and the face recognition unit 17 detects a gesture with an amount greater than or equal to a given amount.

Here, the infrared sensor detects an amount of infrared radiation energy emitted from a passenger, and converts it to a temperature, and can detect a distribution of surface temperature in a wide area. In this case, the change in the temperature of the head of a passenger can be detected to detect the occurrence of trouble. When a non-contact sensor such as an infrared camera is used, the biological information of a passenger can be acquired without making the passenger hold (grasp) a specific sensor.

In the above described judgments (a) through (d), the processing and control unit 40 determines that the output value of the biosensor 21 changes when the change in the output value of the biosensor 21 lasts more than or equal to 5 seconds or the output value of the biosensor 21 intermittently changes within 30 seconds based on the time measurement result of the timer 20. However, the processing and control unit 40 may determine that the biological information changes when the change in the output value of the biosensor 21 is large (e.g. when the changing amount becomes greater than or equal to 10% of the original value) instead. In addition, the processing and control unit 40 determines that a passenger performs a gesture when the output values of the gesture detection units (13, 23, 33) vary over 5 seconds, or the output values of the gesture detection units (13, 23, 33) intermittently change within 30 seconds based on the time measurement result of the timer 20.

In addition, when the train stops abruptly or sways widely, or when passengers get on or off the train, the detection results of the gesture detection units (13, 23, 33) may be the same as the detection results in a case of trouble. To avoid determining that trouble occurs in such a case, the processing and control unit 40 may take the detection result of the vehicle sensor 11 into consideration when determining whether trouble occurs.

The process moves to step S22 when the determination of step S14 becomes Yes based on the above described judgment, while the process moves to step S16 when it becomes No.

When the process moves to step S16, the processing and control unit 40 determines whether it can determine whether trouble occurs accurately (i.e. whether to need check). More specifically, the processing and control unit 40 performs a determination based on whether one of the following conditions (A) and (B) is satisfied.

(A) The biosensor 21 detects the change in biological information, while it can not be determined that a gesture is performed from the detection results of the gesture detection units (13, 23, 33).

(B) When it can be determined that a gesture is performed from the detection result of the pressure sensor 23, the biosensor 21 does not detect the change in biological information, and it can be determined that a gesture is performed from at least one of the detection result of the piezoelectric sensor 13 and the recognition result of the face recognition unit 33.

When one of the above described conditions (A) and (B) is satisfied, the determination of step S16 becomes Yes, and the process moves to step S18. On the other hand, when neither of the above described conditions (A) and (B) is satisfied, the possibility of trouble is assumed to be almost zero and the determination of step S16 becomes No, and the process moves to step S10.

When the process moves to step S18, the processing and control unit 40 checks the state of the passenger identified at step S14. More specifically, the processing and control unit 40 drives the loudspeaker 15 and the microphone 16 by the drive device 9, and asks the identified passenger a question with the sound such as “Are you all right?” using the loudspeaker 15. In addition, the processing and control unit 40 turns on the switch of the microphone 16 at the timing of questioning, and acquires the sound responding to the question from the passenger. Then, the processing and control unit 40 transmits the respondent sound to the sound recognition unit 34, and acquires the sound recognition result by the sound recognition unit 34.

Then, at step S20, the processing and control unit 40 determines whether trouble occurs based on the recognition result of the sound recognition unit 34 and the output from the biosensor 21 and the gesture detection units (13, 23, 33) between step 516 and step S18. For example, the processing and control unit 40 determines that trouble has not occurred when the recognition result of the sound recognition unit 34 is

“I'm OK.” or the like, while it determines that trouble has occurred when the recognition result is “Help.” or “Aiiieee.”. In addition, when the passenger performed a gesture although the respondent sound from the passenger is not obtained, it is determined that trouble has occurred. The processing and control unit 40 may take loudness of the collected respondent sound (dB) into consideration when determining whether trouble occurs.

The process moves back to step S10 when the determination of the step 520 is No (trouble has not occurred), while the process moves to step S22 when it is Yes (trouble has occurred).

When the determination of above described step S20 or the determination of previously described step S14 is Yes and the process moves to step S22, the processing and control unit 40 performs a trouble suppressing process.

More specifically, the processing and control unit 40 controls the drive device 9 to turn the image capture unit 14, the loudspeaker 15, the microphone 16, and the LED 18 toward the identified passenger (passenger who gets involved in trouble) and the area around him/her to suppress trouble. Then, the processing and control unit 40 asks a question such as “Is there anything the matter with you?” or “Are you all right?” from the loudspeaker 15, or makes an announcement such as “The situation will be recorded because trouble may be happening.” from the loudspeaker 15 before recording video captured by the image capture unit 14 and sounds collected by the microphone 16 in the flash memory 30. In addition, the processing device 19 flashes the LED 18, and emits a light beam toward the area where the identified passenger is present. If the processing and control unit 40 performs step S22, a person who is molesting someone is likely to hesitate to continue when the molestation occurs in the car. Thus, the occurrence of molestation after that can be suppressed. The processing and control unit 40 may perform at least one of the above described announcement, image capture, sound recording, and light emission. For example, the LED 18 may be flashed only when it can be determined that vehicle occupancy is high from the captured image of the image capture unit 14 or the detection result of the piezoelectric sensor, or in the night time.

Then, at step S24, the processing and control unit 40 checks whether trouble is calmed down. In this case, the processing and control unit 40 asks questions with the loudspeaker 15 in the same manner as the previously described step S18, and determines whether the trouble is calmed down based on the recognition result of the respondent sound acquired from the microphone 16 by the sound recognition unit 34. The processing and control unit 40 may determine whether the trouble is calmed down based on the detection results of the biosensor 21 and the gesture detection units (13, 23, 33). In this case, it can be determined that the trouble is calmed down if the detection results of the biosensor 21 and the gesture detection units (13, 23, 33) come back to normal values.

When the determination of step S24 is Yes, the process moves back to step S10. On the other hand, when the determination of step S24 is No, the process moves to step S26. At step S26, the processing and control unit 40 reports the occurrence of trouble to a station employee at next stop. In this case, the processing and control unit 40 can report to the station employee at next stop using the communication function achieved by the CPU in FIG. 4 or a communication device coupled to the processing device.

Repeating the above process while a train is traveling enables to detect the occurrence of trouble and calm down the trouble on the train.

As described above in detail, the present embodiment configures the processing and control unit 40 to perform a process according to an action (gesture) of a passenger based on the detection result of the biosensor 21 that detects a change in biological information of the passenger on a train input from the biological information input unit 31 and the recognition results of the gesture detection units (13, 23, 33) that recognize an action of the passenger input from the action information input unit 32. That is to say, the processing and control unit 40 can perform an appropriate process according to the action of the passenger by performing a process taking not only the action recognized by the gesture detection units (13, 23, 33) but also the detection result of the biosensor 21 into consideration (determination of whether trouble occurs and process for calming down the trouble).

In addition, the present embodiment configures the gesture detection units (13, 23, 33) to include different sensors, and the processing and control unit 40 to perform a process according to the action of the passenger based on the recognition results by the sensors input from the action information input unit 32 even when the change in biological information is not input to the biological information input unit 31. Therefore, the execution of the process based on the recognition result of the action (gesture) by the sensors enables to perform the process according to the action of the passenger more appropriately.

In addition, the present embodiment configures the gesture detection units to include the face recognition unit 33, which is a non-contact sensor, and contact-type sensors such as the piezoelectric sensor 13 and the pressure sensor 23, and the processing and control unit 40 to capture images by the image capture unit 14 when the contact-type sensor detects the action of the passenger. This allows the image capture unit 14 to be turned off till the contact-type sensor detects the action of the passenger, and enables to save energy.

In addition, the present embodiment provides the image capture unit 14 higher (ceiling portion) than the contact-type sensor, and thus the image capture unit 14 can mainly capture images of heads of passengers. This enables to protect the privacy of the passengers.

In addition, the present embodiment provides at least a part of the gesture detection units (the pressure sensor 23 in the present embodiment) near the biosensor 21, and thus enables to detect the change in biological information of the hand that performs a gesture by the biosensor 21. In this case, the gesture strongly relates to the change in biological information, and thus the process according to the action of the passenger can be performed more appropriately.

In addition, the present embodiment configures the processing and control unit 40 to perform a process to emit sounds toward the passenger from the loudspeaker 15 as the process according to the action of the passenger, and thus questioning the passenger, warning the act of the passenger, and the like can be performed. This enables to determine whether trouble occurs or perform a process to suppress trouble appropriately.

In addition, the present embodiment may configure the loudspeaker 15 to be a directional loudspeaker that emits sounds in a limited direction. In this case, questioning or warning a passenger can be performed exclusively to a certain passenger (passenger who performed a gesture) or passengers around the certain passenger.

In addition, the present embodiment configures the processing and control unit 40 to receive a sound emitted from a passenger from the microphone 16 that inputs sounds and make the sound recognition unit 34 recognize the sound, and thus the processing and control unit 40 can perform an appropriate process (checking the occurrence of trouble) based on the meaning of the sound emitted from the passenger.

In addition, the present embodiment provides the timer 20 that measures a time during which the biological information of the passenger is changing and a time during which a gesture of the passenger is being recognized, and configures the processing and control unit 40 to perform a process according to the input result of the biological information input unit 31 and the action information input unit 32 and time measurement result of the timer 20. For example, the processing and control unit 40 determines that a gesture has been performed, and performs the process when the change of the input result is continuously detected over 5 seconds or the input result intermittently changes within a given time period (e.g. 30 seconds). This enables to appropriately determine that the gesture has been performed, and thus appropriately perform the process.

In addition, in the present embodiment, passengers are present in movable equipment called train, and the processing and control unit 40 takes the detection result of the vehicle sensor 11 that detects the movement of the train into consideration to perform the process. That is to say, taking the movement of the train caused by abrupt acceleration or deceleration, stop, and getting on and off of the train by passengers into consideration enables to determine whether the passenger has performed a gesture even when the action of the passenger caused by the movement of the train occurs, and thus to perform an appropriate process.

In addition, the present embodiment configures the action information input unit 32 to input the detection result of the pressure sensor 23 that detects the movement of the hand of a passenger, the detection result of the piezoelectric sensor 13 that detects the movement of the foot, and the recognition result of the face recognition unit 33 that detects the movement of the head, and the processing and control unit 40 to determine whether the hand, foot, and head belong to the same person, and thus allows the processing and control unit 40 to relate the detection results of the movement of the hand, foot, and head of the same person to each other. In addition, the present embodiment configures the processing and control unit 40 to perform the process based on the detection results of the movement of the hand, foot, and head of the same person, and thus enables to perform an appropriate process based on the movement of the hand, foot, and head.

In addition, the present embodiment configures the processing and control unit 40 to determine whether the hand and foot belong to the same person based on the positional information of the pressure sensor 23 that has detected the movement of the hand and the positional information of the piezoelectric sensor 13 that has detected the movement of the foot, and thus enables to perform an appropriate determination based on the positional information.

In addition, the present embodiment provides the biological information input unit 31 that inputs the detection result of the biosensor 21 that detects a change in biological information of a passenger in addition to the action information input unit 32, and thus enables to perform an appropriate process based on a gesture and the change in biological information.

In addition, the present embodiment configures the processing and control unit 40 to perform a process based on the movement of the head and the movement of a part other than the head (hand or foot) input from the face recognition unit 33, and thus enables to perform an appropriate process compared to a case of performing a process based on one of the movement of the head and the movement of a part other than the head.

The above described embodiment describes that the processing device 19 has functions of the sound recognition unit 34 and the face recognition unit 33. However, it does not intend to suggest any limitation, and a device having the same function as the sound recognition unit 34 and a device (CPU or the like) having the same function as the face recognition unit 33 may be provided outside the processing device 19.

The present embodiment may employ an acceleration sensor worn by a passenger as a part of the gesture detection units instead of or together with the piezoelectric sensor 13. The acceleration sensor may be embedded in or mounted on shoes, for example. The information of the acceleration sensor is registered in the processing device 19 or the flash memory 30. Then, when the passenger performs a gesture such as stepping a floor in a car, the detection result of the acceleration sensor is input to the processing device 19 (action information input unit 32) by wireless communication. The above described configuration enables to perform the same process as that when the piezoelectric sensor 13 is used. In addition, when the acceleration sensors are located in a toe region and a heel region, a gesture such as stepping a floor performed by a passenger can be detected regardless of the posture of the passenger on the train. As described above, the use of the acceleration sensor enables to detect the occurrence of trouble more accurately.

The above embodiment describes that the biosensor 21 is provided on the strap 22, but does not intend to suggest any limitation. For example, the biosensor 21 may be provided on a watch-type accessory or ring-type accessory worn by a passenger.

The watch-type biosensor may be achieved by the technique disclosed in Japanese Patent Application Publication No. 2007-215749 (U.S. Patent Application Publication No. 2007-0191718). In this case, a wireless communication unit is provided in the accessory, and the biological information detected by the biosensor 21 is radio-transmitted with the wireless communication unit. In addition, the biosensor 21 is registered in the processing device 19. In this case, if a passenger wears the biosensor 21, it is possible to inform the processing device 19 of the possibility of occurrence of molestation with the wireless communication unit when the passenger is molested and the heart rate increases because of it (i.e. the biological information changes) for example. In addition, in this case, the passenger molested does not need to grasp the strap, and thus the occurrence of trouble can be detected more accurately.

In addition, a watch with a biosensor may include an electrode for human body communication and a strap and handrail may include an electrode for human body communication, and the biological information detected by the biosensor may be input to the processing device 19 by human body communication. The watch having a human body communication function may be achieved by the technique disclosed in Japanese Patent No. 4023253.

In addition, a fluid containing bag and a pressure sensor may be located inside a seat (chair) as the biosensor 21 for a passenger who is sitting. In this case, the fluid containing bag is a bag in which air is filled up, and may be located in a seat in accordance with a position of buttocks so that it contacts with the coccyx or ischium. In addition, the pressure sensor detects an internal pressure of the fluid containing bag, and may be a semiconductor sensor, or a vibration-type pressure sensor using a piezoelectric element. In this case, a pulse of the artery propagates to the fluid containing bag while the fluid containing bag is being pressed by the coccyx or ischium, the internal pressure of the fluid containing bag changes, and thus the biological information such as breathing or heart rate can be obtained. The technique disclosed in Japanese Patent No. 3900649 may be used to detect biological information with the fluid containing bag.

The above embodiment describes that the processing device 19 is located in a car, but does not intend to suggest any limitation. For example, the processing device 19 may be located outside a car (e.g. station or railway control center). In this case, each component other than the processing device 19 illustrated in FIG. 1 need to be able to communicate with the processing device 19.

The above embodiment describes that the biosensor 21 and the pressure sensor 23 are provided on the strap 22 in a train, but does not intend to suggest any limitation, and the biosensor 21 and the pressure sensor 23 may be provided on a rod-shaped handrail located in a car.

The trouble handling system 100 can be installed not only on a train but also in moving equipment into which a person can get such as a bus or elevator, and in addition to this, it may be installed in a school, hospital, bank, commerce facility (movie theater and theater), or home.

While the exemplary embodiments of the present invention have been illustrated in detail, the present invention is not limited to the above-mentioned embodiments, and other embodiments, variations and modifications may be made without departing from the scope of the present invention.

1. An electronic apparatus comprising:
a first input unit that inputs a detection result of a biosensor detecting a change in biological information of a subject person;
a second input unit that inputs a recognition result of a recognition device recognizing an action of the person; and
a processor that performs a process according to the action of the person based on input results of the first and second input units.

2. The electronic apparatus according to claim 1, wherein
the recognition device includes different sensors, and
the processor performs the process according to the action of the person based on recognition results of the sensors that are input to the second input unit even when the change in biological information is not input to the first input unit.

3. The electronic apparatus according to claim 1, wherein
the sensors include an image capture device and a contact-type sensor, further comprising:
a controller that captures an image by the image capture device when the contact-type sensor recognizes an action of a person.

4. The electronic apparatus according to claim 3, wherein
the image capture device is located higher than the contact-type sensor.

5. The electronic apparatus according to claim 1, wherein
at least a part of the recognition device is located near the biosensor.

6. The electronic apparatus according to claim 1, wherein
the processor performs a process to emit a sound by a loudspeaker emitting a sound to the person.

7. The electronic apparatus according to claim 6, wherein
the loudspeaker is a directional loudspeaker emitting the sound to a limited direction.

8. The electronic apparatus according to claim 1, wherein
the processor receives a sound emitted from the person from a sound input device that inputs a sound.

9. The electronic apparatus according to claim 8, further comprising:
a sound recognition unit that recognizes a sound received from the sound input device.

10. The electronic apparatus according to claim 1, further comprising:
a timer that measures a time during which biological information of the person is changing and a time during which the action of the person is being recognized, wherein
the processor performs a process according to the input results and a time measurement result of the timer.

11. The electronic apparatus according to claim 1, wherein
the processor performs, when the person is present in moving equipment that is movable, the process taking a detection result of a detection device that detects a movement of the moving equipment into consideration.

12. The electronic apparatus according to claim 1, wherein
the first input unit inputs the change in biological information by human body communication.

13. A processing system comprising:
a biosensor that detects a change in biological information of a person;
a recognition device that recognizes an action of the person; and
the electronic apparatus according to claim 1.

14. The processing system according to claim 13, wherein
the biosensor detects the change in biological information from at least one of a hand and buttocks of the person.

15. An electronic apparatus comprising:
a first input unit that inputs a detection result of a first sensor that detects a movement of a first part of a body;
a second input unit that inputs a detection result of a second sensor that differs from the first sensor and detects a movement of a second part of the body different from the first part; and
a determination unit that determines whether the first part and the second part belong to a same person.

16. The electronic apparatus according to claim 15, further comprising:
processor that performs a process according to detection results input from the first and second input units when the determination unit determines that the first part and the second part belong to the same person.

17. The electronic apparatus according to claim 15, wherein
the determination unit determines whether the first part and the second part belong to the same person based on positional information of the first sensor that has detected the movement of the first part and positional information of the second sensor that has detected the movement of the second part.

18. The electronic apparatus according to claim 15, wherein
the first sensor is a contact-type sensor that contacts the first part to detect the movement of the first part, and
the second sensor is a contact-type sensor that contacts the second part to detect the movement of the second part.

19. The electronic apparatus according to claim 15, wherein
one of the first sensor and the second sensor is a hand detection sensor that detects a movement of a hand, and
the other of the first sensor and the second sensor is a foot detection sensor that detects a movement of a foot.

20. The electronic apparatus according to claim 15, wherein
the first sensor is a contact-type sensor that contacts the first part to detect the movement of the first part, and
the second sensor is a non-contact sensor that detects the movement of the second part without contacting the second part.

21. The electronic apparatus according to claim 15, wherein
the second sensor is a head detection sensor that detects a movement of a head.

22. The electronic apparatus according to claim 15, further comprising:
a third input unit that inputs a detection result of a third sensor that detects a movement of a third part of the body different from the first and second parts.

23. The electronic apparatus according to claim 15, further comprising:
a fourth input unit that inputs a detection result of a biosensor that detects a change in biological information of the body.

24. An electronic apparatus comprising:
a first input unit that inputs a detection result of a non-contact sensor that detects a movement of a head without physical contact;
a second input unit that inputs a detection result of a contact sensor that contacts a part of a body other than the head and detects a movement of the part; and
a processor that performs a process according to detection results input from the first and second input units.

25. The electronic apparatus according to claim 24, further comprising:
controller that performs detection by the non-contact sensor when the contact sensor detects the movement.

26. The electronic apparatus according to claim 24, further comprising:
a determination unit that determines whether a head of which a movement is detected by the non-contact sensor and the part of the body of which a movement is detected by the contact sensor belong to a same person.

27. The electronic apparatus according to claim 26, wherein
the processor performs a process according to detection results input from the first and second input units when a determination result by the determination unit shows that the head of which the movement is detected by the non-contact sensor and the part of the body of which the movement is detected by the contact sensor belong to the same person.

28. The electronic apparatus according to claim 24, wherein
the contact sensor includes a first sensor that detects a movement of a first part of the body and a second sensor that detects a movement of a second part different from the first part.

29. The electronic apparatus according to claim 24, further comprising:
a biological information input unit that inputs a detection result of a biosensor that detects a change in biological information of a body.

30. A processing system comprising:
a first sensor that detects a movement of a first part of a body;
a second sensor that detects a movement of a second part of the body different from the first part; and
the electronic apparatus according to claim 15.

31. A processing system comprising:
a non-contact sensor that detects a movement of a head without physical contact;
a contact sensor that contacts a part of a body other than the head to detect a movement of the part; and
the electronic apparatus according to claim 24.

32. A computer readable storage medium storing a program causing a computer to perform a process, the process comprising:
a first input step that inputs a detection result of a biosensor detecting a change in biological information of a person;
a second input step that inputs a recognition result of a recognition device recognizing an action of the person; and
a processing step that performs a process according to the action of the person based on input results at the first and second steps.

33. A computer readable storage medium storing a program causing a computer to perform a process, the process comprising:
a first input step that inputs a detection result of a first sensor that detects a movement of a first part of a body;
a second input step that inputs a detection result of a second sensor that differs from the first sensor and detects a second part of the body different from the first part; and
a determination step that determines whether the first part and the second part belong to a same person.

34. A computer readable storage medium storing a program causing a computer to perform a process, the process comprising:
a first input step that inputs a detection result of a non-contact sensor that detects a movement of a head without physical contact;
a second input step that inputs a detection result of a contact sensor that contacts a part of a body other than the head and detects a movement of the part; and
a processing step that performs a process according to detection results input from the first and second input units.
